(19) United States
(12) Patent Application Publication
(10) Pub. No.: US 2006/0142910 A1
(43) Pub. Date: Jun. 29, 2006

(54) Method for display of diagnostic procedures based on a repair technician's experience level

(75) Inventors: Jeff B. Grier, Royal Oak, MI (US); Jim J. Cancilla, San Jose, CA (US); Sunil P. Reddy, Corpus Christi, TX (US); Dale A. Trsar, Mt. Prospect, IL (US); Brad Lewis, Gilroy, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated

(21) Appl. No.: 11/024,249

(22) Filed: Dec. 28, 2004

(51) Int. Cl. G01M 17/00

(52) U.S. Cl. 701/29

(57) ABSTRACT

A display device can display a diagnostic procedure used in diagnosing a problem with a vehicle. One or more steps in the diagnostic process may be assigned a level, such as a skill level. A user of the display device, such as a vehicle repair technician, can specify one of the possible levels. The user's selected level can then be used as a basis for altering how the display device displays the diagnostic procedure. For example, in one embodiment, the display device can omit from the displayed diagnostic procedure those steps or sub-steps that have a level that is lower than the user's selected level.

### FIELD OF THE INVENTION

This invention relates generally to vehicle diagnostics. More specifically, it relates to the display of diagnostic procedures based on a repair technician's experience level.

### BACKGROUND OF THE INVENTION

Modern vehicles have become increasingly complex, with a typical vehicle containing various different mechanical and electrical systems. The particular design and operation of these systems usually varies from vehicle manufacturer to vehicle manufacturer. In order to diagnose and repair a problem in a vehicle, a vehicle repair technician must not only be knowledgeable about the general principles of vehicle design (e.g., engines, transmissions, brake systems, air condition systems and others), but the vehicle repair technician must also be knowledgeable about the manufacture's particular design for the vehicle to be diagnosed and repaired. Accordingly, modern vehicles require significant volumes of information to facilitate fault diagnosis and repair.

Vehicle repair technicians commonly use automated diagnostic tools in order to diagnose problems with vehicles. In one use, the diagnostic tools can display a diagnostic procedure to the vehicle repair technician, which the vehicle repair technician can then use to perform various tests on the vehicle and attempt to isolate the particular problem with the vehicle. The diagnostic procedure is typically tailored to the particular vehicle (e.g., make and model) and includes a series of flowchart-like steps for the vehicle repair technician to perform. That is, based on the results of a test at a particular step in the procedure, the procedure may then branch to one of two or more different steps to be performed next.

Vehicle repair technicians have varying levels of experience both in the vehicle repair field generally and more specifically with the particular make and model of vehicle that they are repairing. For some experienced vehicle repair technicians, the diagnostic procedure displayed on the device may provide basic information that is well known by the vehicle repair technician and that the vehicle repair technician simply does not need to see again in the diagnostic procedure. When this type of information is displayed, the vehicle repair technician then has to process the displayed diagnostic procedure in order to determine what is important and needs to be carefully reviewed and what is unimportant and can be ignored.

This analysis that is required by the vehicle repair technician to determine what part of the diagnostic procedure being displayed is useful and what part is not, can increase the time it takes for the vehicle repair technician to parse through the diagnostic routine, thereby increasing the overall time it takes for the vehicle repair technician perform the diagnostic routine. Moreover, it may also increase the frustration level of the vehicle repair technician in using the automatic diagnostic tools and the diagnostic procedures.

Therefore, there exists a need for improved systems and methods for display of vehicular diagnostic procedures.

### SUMMARY OF THE INVENTION

A display device can display a diagnostic procedure used in allowing a vehicle repair technician to diagnose and repair a problem with a vehicle. One or more steps or sub-steps in the diagnostic procedure can be associated with a level, such as a skill level. In one embodiment, relatively more well known or easier diagnostic steps or sub-steps may be assigned a lower level, and relatively less well known or more complicated diagnostic steps may be assigned a relatively higher level. The display device can then use a level selected by the vehicle repair technician as a basis for altering the display of the diagnostic procedure on the display device.

In one embodiment, the vehicle repair technician specifies a level, such as the vehicle repair technician's skill level. The display device then uses the specified level as the basis to alter the display of the diagnostic procedure on the display device. For example, the display device may omit those steps or sub-steps in the diagnostic procedure that have a level that is lower than the level specified by the vehicle repair technician. In various embodiments, the vehicle repair technician may subsequently select one or more of the omitted steps to then be displayed on the display device.

In another embodiment, the display device uses a feedback mechanism to dynamically adjust the experience level used in displaying a diagnostic procedure. For example, the vehicle repair technician might initially select an experience level or the display device might default to using a default experience level. As the vehicle repair technician traverses the diagnostic procedures, the display device might use requests made by the vehicle repair technician to view omitted steps or sub-steps, the absence of requests made by the vehicle repair technician to view omitted steps or sub-steps, selections by the vehicle repair technician to skip one or more displayed steps or sub-steps, or other actions as a basis for changing the experience level used in displaying the diagnostic procedure.

These as well as other aspects and advantages of the present invention will become apparent from reading the following detailed description, with appropriate reference to the accompanying drawings.

### BRIEF DESCRIPTION OF THE DRAWINGS

Exemplary embodiments of the present invention are described herein with reference to the drawings, in which:

FIG. 1 is block diagram of an exemplary vehicle diagnostic procedure in which a skill level is associated with selected steps in the diagnostic procedure;

FIG. 2 depicts an exemplary display device for displaying a diagnostic procedure based on a skill level of a vehicle repair technician, such as the diagnostic procedure depicted in FIG. 1;

FIG. 3A depicts the display device displaying the diagnostic procedure of FIG. 1 for a selected vehicle repair technician skill level of one;

FIG. 3B depicts the display device displaying the diagnostic procedure of FIG. 1 for a selected vehicle repair technician skill level of three;

FIG. 3C depicts the display device displaying an alternate display of the diagnostic procedure of FIG. 1 for a selected vehicle repair technician skill level of three;

FIG. 4 is a flowchart of an exemplary method for displaying vehicle diagnostic procedures on a device; and

FIG. 5 is a flowchart of an exemplary method for displaying vehicle diagnostic procedures on a device.

### DETAILED DESCRIPTION OF EXEMPLARY EMBODIMENTS

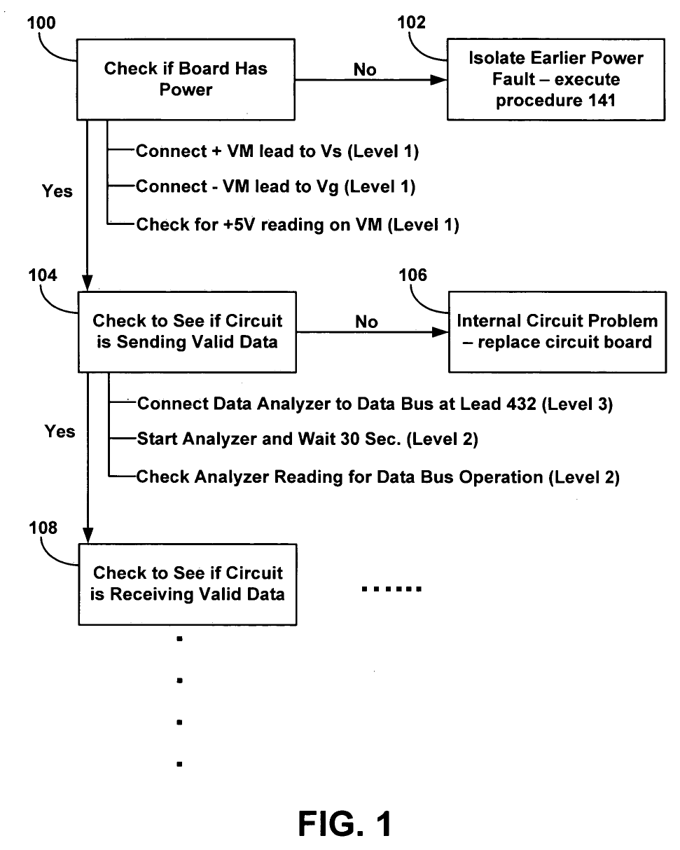

FIG. 1 is block diagram of an exemplary vehicle diagnostic procedure in which a skill level is associated with selected steps in the diagnostic procedure. A diagnostic device can display this procedure, and it can use the associated skill levels in order to tailor the display of the diagnostic procedure to the skill level of a vehicle repair technician using the device. For example, where the repair technician has a relatively high skill level, the diagnostic device might only display more advanced steps in the diagnostic procedure and might omit less advanced steps in the diagnostic procedure. However, where the repair technician has a relatively lower skill level, then the diagnostic device might display more or all of the steps in the diagnostic procedure to the vehicle repair technician.

This diagram illustrates a diagnostic procedure that is used to diagnose a problem with a particular circuit board in a vehicle; however, it is provided merely by way of example, and it should be understood that the principles discussed herein are not limited to any particular type of problem, any particular vehicle system, any particular vehicle, any particular type of equipment used in the diagnostic process or any other particular factor. Rather, the principles discussed herein may be broadly applied to any diagnostic procedure used in diagnosing and repairing a problem with a vehicle. In fact, the principles discussed here are not even limited to a vehicle, and might also be applied to other machinery or equipment and to diagnostic procedures in general.

At Step 100, the vehicle repair technician begins by checking to see if the circuit board has power. This particular step includes three sub-steps that the vehicle repair technician would actually perform to see if the circuit board has power—“connecting +VM lead to Vs”, “connecting −VM lead to Vg” and “Check for +5V reading on VM”. From the general step of checking for power, these sub-steps describe in more detail how the vehicle repair technician connects a voltmeter to various points in the circuit board and then reads the voltmeter's output in order to determine whether the circuit board has power. It should be understood that the terms step and sub-step as used herein are merely arbitrary, and a sub-step might actually just be considered another step in the diagnostic procedure.

Each of the sub-steps is assigned a skill level. In this example, a step or sub-step might be assigned one of four possible skill levels—skill level 1, skill level 2, skill level 3 and skill level 4—and the sub-steps to Step 100 are each assigned a skill level of 1. In other embodiments, however, a greater or fewer number of possible skill levels might be used. Although four skill levels are possible in this example, the diagnostic procedure only includes sub-steps that have skill levels 1, 2 and 3, and therefore a diagnostic procedure does not necessarily need to include steps or sub-steps corresponding to all the possible skill levels.

In checking the power at Step 100, if the voltmeter does not read “+5V” after being properly connected, then the circuit board is not receiving power. The vehicle repair technician then proceeds to Step 102, which directs the vehicle repair technician that there is a power fault somewhere before the circuit board, and that the vehicle repair technician should execute procedure 141 in order to isolate that earlier power fault. If the voltmeter does read “+5V” after being properly connected, then the circuit board is obtaining power and the vehicle repair technician proceeds to Step 104 in order to continue diagnosing the problem.

At Step 104, the vehicle repair technician checks to see if the circuit is sending valid data. This particular step also includes three sub-steps that the vehicle repair technician would perform in order to see if the circuit is sending valid data. Thus, to check to see if the circuit is transmitting valid data, the vehicle repair technician would: 1) connect a data analyzer to the data bus at lead 432, 2) start the analyzer and wait 30 seconds, and 3) check the analyzer reading to determine whether the data bus is operating properly. The first of these sub-steps is assigned a skill level of three, and the remaining two sub-steps are assigned a skill level of two.

If the circuit is not sending valid data, then the vehicle repair technician proceeds to Step 106. At Step 106, the vehicle repair technician determines that there is an internal problem with the circuit board, and as a result, the vehicle repair technician fixes the problem by replacing the circuit board. If the circuit is sending valid data, however, then the repair technician proceeds to Step 108. At this step, the vehicle repair technician checks to see if the circuit is receiving valid data. That is, the problem with the circuit might be that the input to the circuit is corrupted or otherwise in error. For simplicity of illustration, only Steps 100, 102, 104, 106 and 108 of the diagnostic procedure are shown in this figure. However, the diagnostic procedure may include additional steps that are not depicted in this figure, and therefore the diagnostic procedure may continue from Step 108 until the problem has been diagnosed or the diagnostic procedure completed.

As previously described, the sub-steps for Steps 100 and 104 are each assigned a skill level. The assignment of the skill level to a particular step or sub-step is arbitrary, and any step or sub-step may potentially be assigned any available skill level. In this example, the skill levels assigned to the sub-steps are generally correlated to the expected knowledge of repair technicians and the relative simplicity of performing the sub-step. For example, checking whether a circuit board has power is generally a task that many repair technicians know how to do without having to further describe to them how to find the power and ground terminals, connect a voltmeter and read the output of the voltmeter. Therefore, the sub-steps for Step 100 are assigned a skill level of one, which is the easiest skill level.

However, repair technicians are generally less knowledgeable about how to check to see if a circuit, and in particular this specific circuit, is sending valid data. Checking to see if a circuit is properly sending data might involve using more complicated diagnostics tools, might require more specific knowledge about the interconnections of the particular circuit, and might require more knowledge about what data is being transmitted. In practice, the average vehicle repair technician is less likely to know the information needed to check to see if the circuit is properly transmitting data than the information needed to check to see if the circuit has power. Therefore, these three sub-steps are assigned skill levels higher than one. Since vehicle repair technicians may be somewhat more familiar with the operation of a data analyzer (or other such device) after it is properly connected than they are familiar with the particular pin(s) in this circuit with which the data analyzer should be connected, the first sub-step is assigned a skill level of three and the remaining two sub-steps of Step 104 are assigned the relatively easier skill level of two.

In one implementation, the diagnostic procedure might be stored in an electronic file or other such storage mechanism accessible by the display device. The electronic file might use a variety of different formats and internal data structures to store the diagnostic procedure. For example, the electronic file might use a flat file format, or it might use a database or other relatively more advanced data structure. These are merely examples and others might alternatively be used.

Regardless of the particular implementation for storing the diagnostic procedure, each step and sub-step in the diagnostic procedure might have a number of associated fields (e.g., one or more pointers to the next step or sub-step, whether the step requires input from the vehicle repair technician prior to passing to the next step or sub-step, what input is required, etc . . . ). One of the associated fields might store the skill level corresponding to this step or sub-step. Thus, the skill levels might be assigned at the time the diagnostic procedure is created. In one embodiment, they are not later alterable by a user of the display device (e.g., the vehicle repair technician); however, in another embodiment they are alterable by the user of the display device.

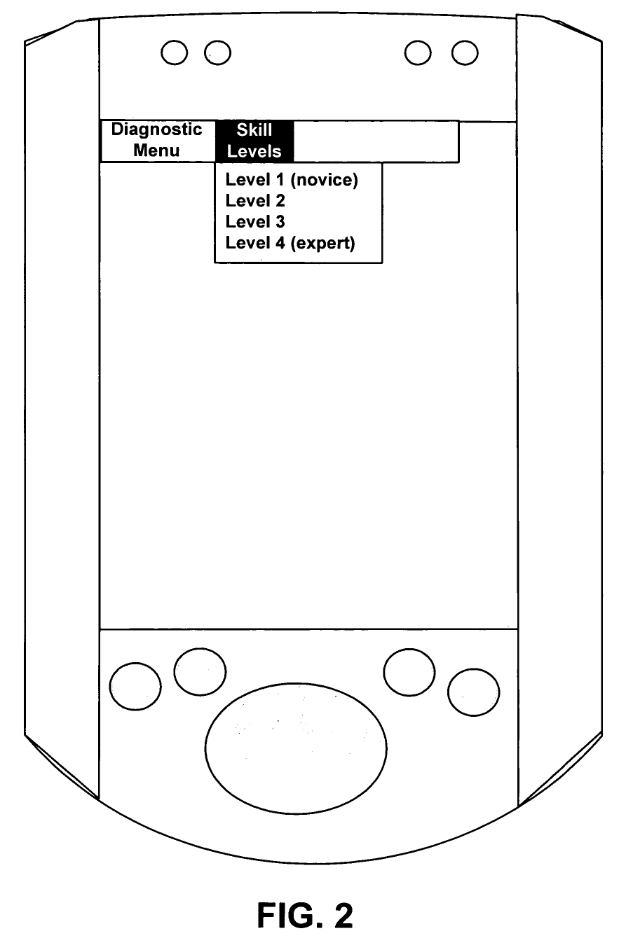

FIG. 2 depicts an exemplary display device for displaying a diagnostic procedure based on a skill level of a vehicle repair technician, such as the diagnostic procedure depicted in FIG. 1. Any type of device might be used to display a diagnostic procedure to a vehicle repair technician. For example, this figure illustrates a personal digital assistant (“PDA”) 200 as the display device. Alternate embodiments might use other handheld device or even non-handheld devices. For example, a desktop computer, free standing diagnostic equipment, a laptop computer or other such device devices might also be used.

The PDA 200 includes a graphical user interface, with which the vehicle repair technician can interact in order to input data into the PDA 200 and also to view data outputted by the PDA 200. In this example, the vehicle repair technician has selected the “skill levels” dropdown menu. Once selected, the dropdown menu displays the four possible skill levels, and the vehicle repair technician can then select one of the skill levels from the dropdown menu. Thus, the vehicle repair technician can select the desired skill level. The graphic user interface is merely exemplary in nature, and a command line interface or any other type of user interface might alternatively be used.

The PDA 200 might include memory, which can store one or more diagnostic procedures, such as the diagnostic procedure of FIG. 1. Alternatively, the PDA 200 might include a wired or wireless network connection, which the PDA can use to request and retrieve a diagnostic procedure stored remotely from the PDA 200. Where the network connection is a wireless network connection, a variety of wireless protocols might be used, such as IEEE 802.11x, IEEE 802.16, IEEE 802.20, code division multiple access (“CDMA”), time division multiple access (“TDMA”), frequency division multiple access (“FDMA”), Global System for Mobile Communications/General Packet Radio Service (“GSM/GPRS”), Bluetooth or others. In one embodiment, the PDA 200 also includes a dropdown menu that the vehicle repair technician can use to select one or more diagnostic procedures from a list of available diagnostic procedures.

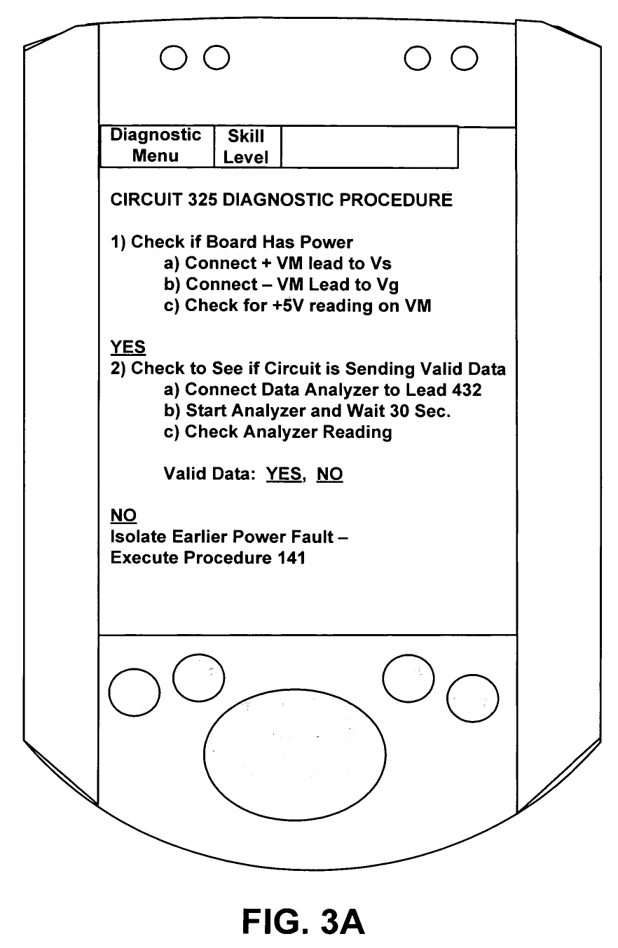

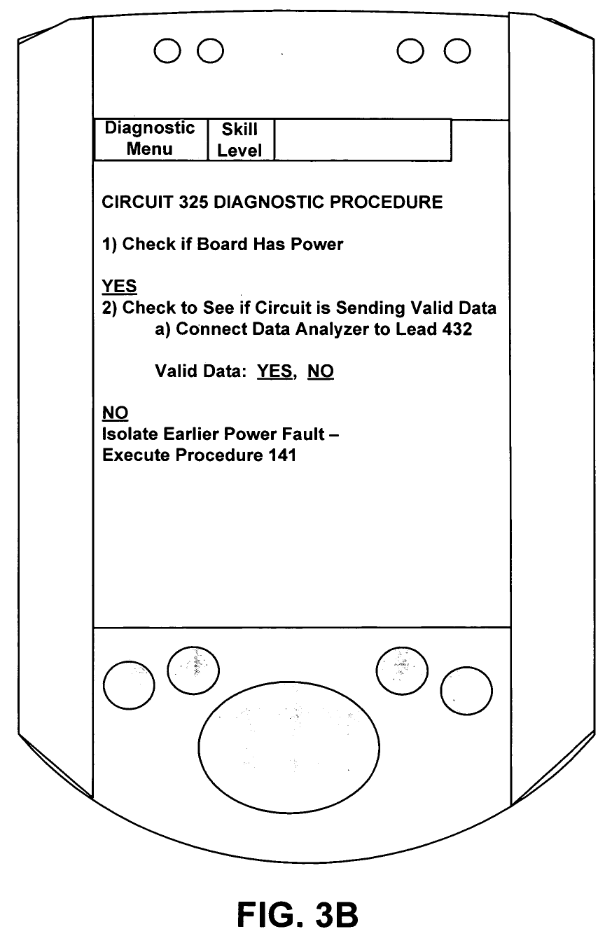

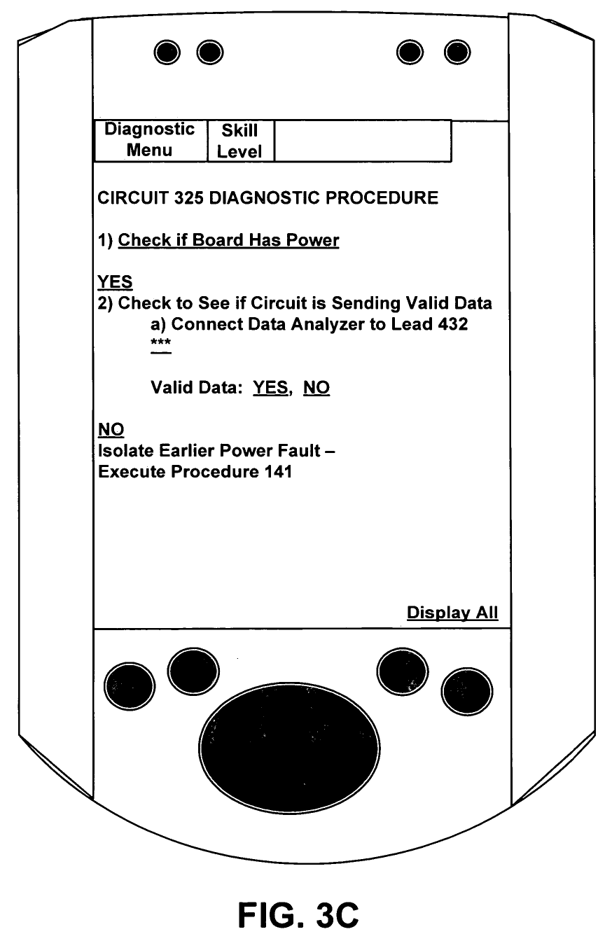

FIG. 3A depicts the display device displaying the diagnostic procedure of FIG. 1 for a selected vehicle repair technician skill level of one. In this example, the display device only displays those steps and sub-steps in the diagnostic procedure that have a skill level that is equal to or greater than the selected vehicle repair technician skill level. Since the selected skill level of one is the relatively lowest skill level that can be selected, then all the steps of the diagnostic procedure would have a skill level that is at least this high and therefore all the steps of the diagnostic procedure are displayed on the PDA 200 to the vehicle repair technician. That is, no skill level of a step or sub-step would be less than the selected skill level of one, and therefore no step or sub-step would be omitted on the display of the PDA 200.

A variety of different formats might be used to display the diagnostic procedure on the diagnostic device. In this example, the PDA 200 formats the diagnostic procedure as a numbered list. Thus, the actual display on the PDA 200 is different than the conceptual representation used in FIG. 1 of the diagnostic procedure. It should be understood; however, that this particular format is merely exemplary in nature and other formats might alternatively be used. Steps 100 and 102 are displayed as numbers one and two respectively in the numbered list. Their corresponding sub-steps are also displayed using labels “a”, “b” and “c”.

At Step 100, the diagnostic procedure branches to Step 102 if the circuit board does not have power, or alternatively it branches to Step 104 if the circuit board does have power. This branch is designated by the labels “YES” and “NO” on the display. Thus, the procedure progresses from “1)” to one of the “YES” or “NO” labels depending on whether the circuit board has power. The “NO” label corresponds to Step 102, and this step and its sub-steps are displayed under the “NO” label. The “YES” label corresponds to Step 104, and this step and its corresponding sub-steps are displayed under the “YES” label.

At the “YES” label, the PDA 200 displays the further actions to be performed by the vehicle repair technician. Thus, after proceeding to this step, the vehicle repair technician would then perform sub-steps a-c. At sub-step c, the vehicle repair technician must determine whether the circuit is sending data. Therefore, immediately after this sub-step the display device displays corresponding “yes” and “no” responses to this determination. These two responses are underlined and represent links that the vehicle repair technician and select and then follow, similar to hyperlinks in a web browser.

For example, if the vehicle repair technician determines that the analyzer shows that the circuit is sending valid data, then the vehicle repair technician would select the “yes” response, and the PDA 200 would update the display to show Step 108. It might potentially show other future steps as well. However, if the vehicle repair technician determines that the analyzer shows that circuit is not sending valid data, then the vehicle repair technician would select the “no” response, the PDA 200 would then update the display to show Step 106.

These navigation functions allow for the vehicle repair technician to interactively navigate the diagnostic procedure, such as when the diagnostic procedure is too large to be entirely displayed on the PDA 200 at one time or when the number of branches would make the diagnostic procedure too cumbersome to be entirely displayed at one time. It should be understood, however, that this display format is merely exemplary in nature and other display formats and navigation methods might alternatively be used.

FIG. 3B depicts the display device displaying the diagnostic procedure of FIG. 1 for a selected vehicle repair technician skill level of three. In this display, the PDA 200 does not display steps that have an associated skill level less of less than three (e.g., skill level 1 or skill level 2). Thus, the PDA 200 only displays the steps that have an associated skill level of three or greater (e.g., skill level three or skill level four). The PDA 200 would also continue to display those steps that do not have any associated skill level, such as Steps 100, 102, 104, 106 and 108.

As depicted in the figure, the PDA 200 omits all the sub-steps from Step 100 (e.g., those under the “1)” label on the display), since all those sub-steps have a skill level of one. The display also omits the second and third sub-steps for Step 104 (e.g., those under the “2)” label on the display), since those steps have a skill level of two. Thus, a relatively more advanced vehicle repair technician (e.g., one that selects a skill level of three or four) would likely already know these steps and therefore would not need to view them as part of the diagnostic procedure. These omissions may therefore streamline the diagnostic display shown to the vehicle repair technician and allow the vehicle repair technician to more easily view and process the diagnostic procedure.

FIG. 3C depicts the display device displaying an alternate display of the diagnostic procedure of FIG. 1 for a selected vehicle repair technician skill level of three. Although the PDA 200 might initially omit steps or sub-steps based on the selected skill level of the vehicle repair technician, for various reasons the vehicle repair technician might still want to see these omitted steps. For example, even an experienced vehicle repair technician might not be familiar with a particular procedure or step and therefore might want to see the omitted information.

In this alternate display, the “1) Check if Board Has Power” label for Step 100 operates as a hyperlink and is therefore underlined. The underlining alerts the vehicle repair technician that one or more sub-steps were omitted from the display for this step. In order to view the omitted sub-steps, the vehicle repair technician can simply select this label with an input device (e.g., a pointer, stylus or other device). In response to the selection, the PDA 200 can update the display to show the previously omitted sub-steps for this step. The underlining is merely exemplary in nature, and a different color, bold, italics or some other indicator might be used to alert the vehicle repair technician to the omitted steps.

Since this display uses a selected skill level of three, the second and third sub-steps of Step 104 are omitted, because they have corresponding skill levels of two. The first sub-step is still displayed, because it has a corresponding skill level of three. Below the first sub-step, the PDA 200 displays “***”. This indicates to the vehicle repair technician that sub-steps have been omitted, and the vehicle repair technician can again select this hyperlink in order to view the omitted steps. The asterisks are arbitrary, and any other indicator might alternatively be used to indicate the omitted steps.

The vehicle repair technician might also view omitted steps by using the dropdown menu to change the selected skill level. Once, the vehicle repair technician makes the new selection, then the PDA 200 can update the display accordingly. For example, if the vehicle repair technician uses the dropdown menu to change from a skill level of three to a skill level of two, then the device can update the display to include steps or sub-steps that have a skill level of two and which where previously omitted from the display. Additionally, the PDA 200 might display a “Display All” hyperlink that the vehicle repair technician can select in order to quickly view all the omitted steps.

In the previously described operation, the vehicle repair technician explicitly selects an experience level, such as from a drop down menu. In other alternate embodiments, however, the diagnostic device might employ a feedback mechanism to determine an experience level of the vehicle repair technician without necessarily requiring an explicit selection from the vehicle repair technician. The feedback mechanism might be the sole method for determining the experience level used in displaying a diagnostic procedure, or it might be used in conjunction with explicit selections from the vehicle repair technician.

For example, the display device might display the diagnostic procedure without first receiving an explicit selection of an experience level from the vehicle repair technician. In this case, the display device might default to initially using a default experience level. The default experience level might be preprogrammed into the display device, and it might or might not alter be alterable by the vehicle repair technician. Once the display device displays the diagnostic procedure, it might monitor subsequent requests from the vehicle repair technician. Based on the requests, the display device might then adjust the experience level.

In one embodiment, the display device might record the number of requests to view additional steps or sub-steps in the diagnostic procedure, such as were omitted because they have an associated skill level that is less than the default experience level. If the vehicle repair technician makes more than a predetermined number of requests to view the omitted steps or sub-steps, the display device might responsively decrease the experience level used in displaying subsequent steps in the diagnostic procedure. If the vehicle repair technician does not make any requests, or makes less than a predetermined number, then the display device might increase the experience level used in displaying subsequent steps in the diagnostic procedure. In this way, the display device might adjust the experience level based on actions other than an explicit selection of an experience level by the vehicle repair technician.

In another embodiment, the display device might employ a more interactive method that allows the vehicle repair technician more directly aid in training the display device in order to determine an experience level. For example, the display device might first begin by using a default experience level to display the diagnostic procedure. Along with one or more steps in the procedure, the display device might display a “skip” or other such indicator. As the vehicle repair technician progresses through the diagnostic procedure, the vehicle repair technician might select the respective “skip” indicators for one or more steps.

Based on the vehicle repair technician's selection of “skip” indicators, the display device might alter the experience level used in displaying the diagnostic procedure. For example, if the vehicle repair technician selects more than a predetermined number of levels to skip that have an associated experience level that is equal to or greater than the default experience level, then the display device might alter the experience level used in displaying steps and sub-steps in the diagnostic procedure from the default experience level to a higher experience level. The display device can then use the higher experience level when displaying subsequent steps or sub-steps in the diagnostic procedure.

In another embodiment, the display device might use a combination of an explicit selection of an experience level by the vehicle repair technician and one or more feedback mechanisms. For example, the vehicle repair technician might initially select an experience level to be used in displaying the diagnostic procedure. Based on subsequent actions of the diagnostic repair technician, such as making requests to view omitted steps or sub-steps or making selections to skip one or more steps or sub-steps, the display device might then alter the initially selected experience level and then use the different experience level when displaying subsequent steps of the diagnostic procedure on the display device.

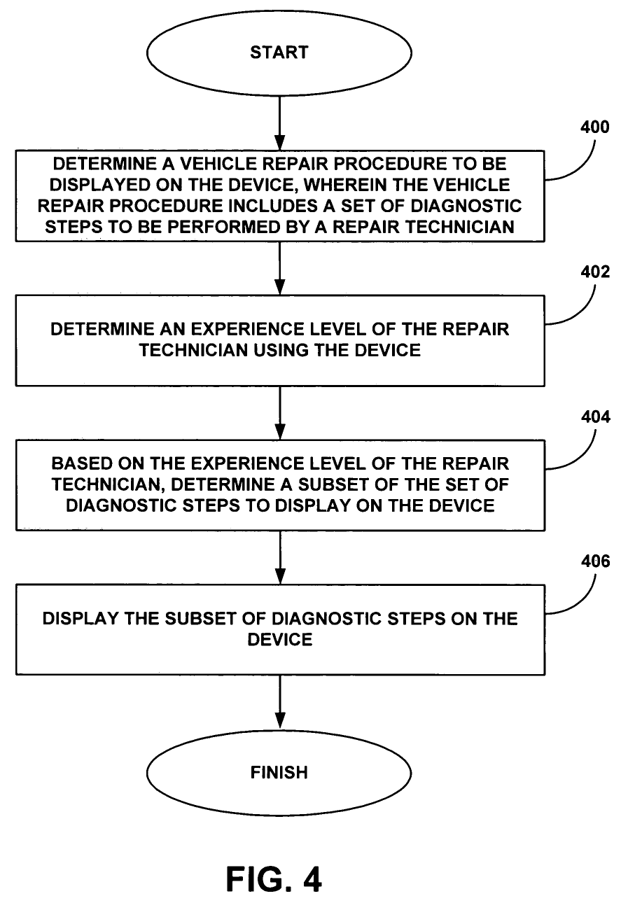

FIG. 4 is a flowchart of an exemplary method for displaying vehicle diagnostic procedures on a device. At Step 400, the device determines a vehicle diagnostic procedure to be displayed on the device, wherein the vehicle diagnostic procedure includes a set of diagnostic steps to be performed by a repair technician. In one embodiment, the device displays a list of available diagnostic procedures, and the user of the device selects one of the diagnostic procedures to be display on the device. For example, the device might display the list of available diagnostic procedures in a dropdown menu, which may also include submenus allowing for easy navigation of a large number of possible diagnostic procedures. In another embodiment, the devices does not display a list of all available diagnostic procedures but rather the user of the device enters an identifier for a particular diagnostic procedure, such as at a command line or other input prompt, to be displayed on the device. Other methods of determining the vehicle repair procedure are also possible.

At Step 402, the device determines an experience level of the repair technician using the device. As previously described, the repair technician might input the particular experience level to be used in displaying the diagnostic procedure or the device might use a default experience level. Alternatively, the experience level might be derived from one or more prior actions of the repair technician, such as actions taken in traversing a diagnostic procedure that was previously displayed on the device, or in traversing a portion of a diagnostic procedure that is currently displayed on the device. Based on the experience level of the repair technician, the device determines a subset of the set of diagnostic steps to display on the device, as shown at Step 404.

Where the device is not already displaying the diagnostic procedure, the determination of the subset might occur prior to beginning to display the diagnostic procedure on the device. However, where the device is already displaying the diagnostic procedure on the device, then this process might alter the steps or sub-steps that are currently being displaying on the device. For example, depending on whether the subset includes more or less steps than the subset of steps currently being displayed on the device, the display might be updated to include additional steps or to remove steps in the diagnostic procedure. Thus, upon the determination of the subset of diagnostic steps, the vehicle repair technician might see an update of what is displayed on the device. However, where the device is not already displaying the diagnostic procedure, then this process might occur transparently to the repair technician.

In determining the subset of the set of diagnostic steps, for example, the device might go through the entire diagnostic procedure and remove the steps that have an associated experience level that is less than that of the repair technician. Thus, the subset might include only those steps that have an experience level that is at least as high as the skill level of the repair technician. Where the device is currently displaying a subset of the diagnostic procedure, this might result in the creation of a new subset that has additional steps or sub-steps that are not in the subset currently being displayed on the device, such as when the device transitions to using a lower experience level. Alternatively, this might result in the creation of a new subset that has fewer steps or sub-steps than are in the subset currently being displayed on the device.

Depending on the experience level of the repair technician, the subset might include all of the steps in the diagnostic procedure. This might occur where the repair technician has the lowest possible experience level (e.g., experience level 1) and no steps in the diagnostic procedure are omitted). Alternatively, the subset might include less than all of the steps in the diagnostic procedure, such as where the repair technician has an experience level higher than the lowest possible experience level and some steps in the diagnostic procedure are omitted. After determining the subset, the device displays the subset of diagnostic steps on the device, as shown at Step 406.

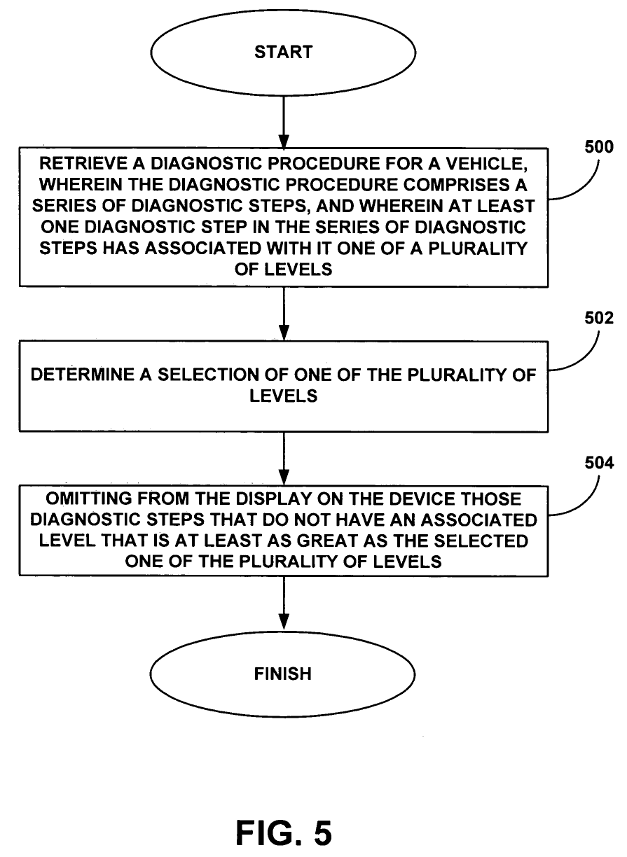

FIG. 5 is a flowchart of an exemplary method for displaying vehicle diagnostic procedures on a device. At Step 500, the device retrieves a diagnostic procedure for a vehicle, wherein the diagnostic procedure comprises a series of diagnostic steps, and wherein at least one diagnostic step in the series of diagnostic steps has associated with it one of the plurality of levels. The device might retrieve the diagnostic procedure in a variety of different ways. For example, the diagnostic procedure might be stored in memory within the device. In this case, the device could retrieve the diagnostic procedure by obtaining it the memory. This might be performed, for instance, in response to an indication from the user, such as via an input device, to display a particular diagnostic procedure.

In another example, the diagnostic procedure might not be stored in the device. In order to obtain the diagnostic procedure, the device might issue a request to obtain the diagnostic procedure. The request might be made to another device, such as a centralized repository of diagnostic information, with which the requesting device can communicate over one or more data networks (e.g., intranet, Internet or some other computer network). The device might make the request via a wireless communication interface, for example where the device can wirelessly access one or more of the interconnecting computer networks. Alternatively, the device might make the request via a wired connection with one or more of the interconnecting computer networks.

At Step 502, the device determines a selection of one of the plurality of levels. For example, a user of the device might make a selection of one of the plurality of levels through an input device. Then, the device omits from the display on the device those diagnostic steps that do not have an associated level that is at least as great as the selected one of the plurality of levels, as shown at Step 504. For example, the device might display those diagnostic steps that have a difficulty level that is at least as great as the selected one of the plurality of levels and might also display those diagnostic steps that do not have an associated level.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. § 112, paragraph 6, and any claim without the word “means” is not so intended. Therefore, all embodiments that come within the scope and spirit of the following claims and equivalents thereto are claimed as the invention.

We claim:

1. A method for displaying vehicle diagnostic procedures on a device, the method comprising:
determining a vehicle diagnostic procedure to be displayed on the device, wherein the vehicle diagnostic procedure includes a set of diagnostic steps to be performed by a repair technician;
determining an experience level of the repair technician using the device; and
based on the experience level of the repair technician, determining a subset of the set of diagnostic steps to display on the device.

2. The method of claim 1, wherein determining an experience level of the repair technician using the device comprises receiving from the repair technician via an input mechanism an indication of the experience level of the repair technician.

3. The method of claim 1, wherein a plurality of steps in the set of diagnostic steps has a corresponding experience level, and wherein determining the subset of the set of diagnostic steps comprises:
for each diagnostic step in the set of diagnostic steps that has a corresponding experience level, determining if the corresponding experience level equals or exceeds the experience level of the repair technician; and
if the corresponding experience level equals or exceeds the experience level of the vehicle repair technician, then adding the diagnostic step to the subset of diagnostic steps.

4. The method of claim 3, further comprising adding to the subset of diagnostic steps those diagnostic steps in the set of diagnostic steps that do not have a corresponding experience level.

5. The method of claim 1, wherein the subset of the diagnostic steps includes all the steps in the set of diagnostic steps.

6. The method of claim 1, further comprising displaying the subset of diagnostic steps on the device.

7. The method of claim 6, further comprising:
after performing the step of displaying the subset of the diagnostic steps on the device, receiving from the repair technician an indication to display at least one diagnostic step that is in the set of diagnostic steps but not in the subset of diagnostic steps; and
displaying the at least one diagnostic step.

8. The method of claim 6, further comprising:
after performing the step of displaying the subset of the diagnostic steps on the device, receiving from the repair technician an indication to display the set of diagnostic steps; and
displaying the set of diagnostic steps on the device.

9. A method for displaying vehicle diagnostic procedures, the method comprising:
retrieving a diagnostic procedure for a vehicle, wherein the diagnostic procedure comprises a series of diagnostic steps, and wherein at least one diagnostic step in the series of diagnostic steps has associated with it one of a plurality of levels;
determining a selection of one of the plurality of levels; and
omitting from the display on the device those diagnostic steps in the series of diagnostic steps that do not have an associated level that is at least as great as the selected one of the plurality of levels.

10. The method of claim 9, wherein retrieving the diagnostic procedure comprises receiving the diagnostic procedure via a wireless communication interface.

11. The method of claim 9, wherein determining the selection of one of the plurality of levels comprises obtaining the selection via an input mechanism for the device.

12. The method of claim 9, wherein determining the selection of one of the plurality of levels comprises:
displaying on the device the plurality of levels; and
receiving from the user a selection of one of the plurality of levels.

13. The method of claim 12, wherein displaying on the device the plurality of levels comprises displaying the plurality of levels in drop down menu.

14. The method of claim 9, further comprising:
displaying on the device an indication that at least one diagnostic step in the series of diagnostic steps has been omitted from those diagnostic steps displayed on the device;
receiving an indication to display the omitted diagnostic step; and
displaying the omitted diagnostic step.

15. The method of claim 9, further comprising:
after performing the step of omitting from the display those diagnostic steps in the series of diagnostic steps that do not have an associated level that is at least as great as the selected one of the plurality of levels, receiving an indication from the user of the device to display all the diagnostic steps in the series of diagnostic steps; and
responsively displaying all the diagnostic steps in the series of diagnostic steps.

16. A device for displaying a diagnostic procedure, the device comprising:
a memory for storing at least one diagnostic procedure, wherein the diagnostic procedure comprises a series of diagnostic steps, and wherein at least one diagnostic step in the series of diagnostic steps has associated with it one of a plurality of difficulty levels;
a input mechanism for receiving an indication of one of the plurality of difficulty levels; and
a display mechanism for displaying the at least one diagnostic procedure.

17. The device of claim 16, further comprising a formatting mechanism for formatting the at least one diagnostic procedure based in the indication of the one of the plurality of difficulty levels, and for passing the formatted diagnostic procedure to the display mechanism.

18. The device of claim 16, further comprising a wireless communications interface for wirelessly receiving the at least one diagnostic procedure.

19. The device of claim 16, wherein the wireless communications interface is an IEEE 802.11x, IEEE 802.16 or IEEE 802.20 wireless communications interface.

20. The device of claim 16, wherein the device is a handheld device.

21. The device of claim 16, further comprising a data collection interface for interfacing with a vehicle and for collecting data from one or more components in the vehicle.

22. A computer readable medium comprising instructions for causing a processor to:
retrieve a diagnostic procedure for a vehicle, wherein the diagnostic procedure comprises a series of diagnostic steps, and wherein at least one diagnostic step in the series of diagnostic steps has associated with it one of a plurality of levels;
determine a selection of one of the plurality of levels; and
omit from a diagnostic procedure displayed on the device those diagnostic steps in the series of diagnostic steps that do not have an associated level that is at least as great as the selected one of the plurality of levels.

23. The computer readable medium of claim 23, further comprising instructions for causing a processor to:
display on the device an indication that at least one diagnostic step in the series of diagnostic steps has been omitted from those diagnostic steps displayed on the device;
receive an indication to display the omitted diagnostic step; and
displaying the omitted diagnostic step.

24. The computer readable medium of claim 22, further comprising instructions for causing the processor to:
after performing the step of omitting from a diagnostic procedure displayed on the device those diagnostic steps in the series of diagnostic steps that do not have an associated level that is at least as great as the selected one of the plurality of levels, receive an indication from the user of the device to display all the diagnostic steps in the series of diagnostic steps; and
responsively display all the diagnostic steps in the series of diagnostic steps.

25. The computer readable medium of claim 22, further comprising instruction for causing the processor to:
after performing the step of omitting from a diagnostic procedure displayed on the device those diagnostic steps in the series of diagnostics steps that do not have an associated level that is at least as great as the selected one of the plurality of levels, receive a second selection of one of the plurality of levels; and
responsively display all the diagnostic steps in the series of diagnostic steps that have an associated level that is at least a great as the second selection of one of the plurality of levels.

26. A method for displaying a diagnostic procedure on a device, the method comprising:
determining an first difficulty level;
displaying on the device a first subset of steps in a diagnostic procedure, wherein steps in the diagnostic procedure as an associated difficulty level, and wherein the first subset of steps does not includes steps that have an associated difficulty level that is less than the first difficulty level;
monitoring actions of a user in traversing the first subset of steps displayed on the diagnostic device;
based on the actions of a user in traversing the first subset of steps displayed on the diagnostic device, creating a second subset of steps in the diagnostic procedure, wherein the second subset of steps does not include steps that have an associated difficulty level that is less than a second difficulty level, and wherein the second difficulty level is different than the first difficulty level; and
displaying the second subset of steps on the diagnostic device.

27. The method of claim 26, wherein monitoring the actions of the user comprises, determining a number of times a user requests to view a step in the diagnostic procedure that is not in the first subset of steps.

28. The method of claim 26, wherein monitoring the actions of the user comprises determining a number of times a user requests to skip a step in the first subset of steps that is displayed on the device.

29. The method of claim 26, wherein monitoring the actions of the user comprises receiving from the user an explicit selection of the second difficulty level.

30. The method of claim 26, wherein determining the initial difficulty level comprises receiving from a user of the device an indication of the initial difficulty level.

31. The method of claim 26, wherein determining the first difficulty level comprises using a default difficulty level preprogrammed into the device.

32. The method of claim 26, wherein all steps in the diagnostic procedure have an associated difficulty level.

33. The method of claim 26, wherein at least one step in the diagnostic procedure does not have an associated difficulty level.

34. The method of claim 26, wherein the diagnostic procedure is a procedure for diagnosing a problem with a vehicle.
